(19) United States
(12) Patent Application Publication
(10) Pub. No.: US 2009/0074959 A1
(43) Pub. Date: Mar. 19, 2009

(54) METHOD OF PRODUCING HERMETICALLY-SEALED OPTICAL FIBERS AND CABLES WITH HIGHLY CONTROLLED AND COMPLEX LAYERS

(76) Inventors: Omur M. Sezerman, Kanata (CA); Eric Canuteson, South Pasadena, CA (US)

Correspondence Address: JONES, TULLAR & COOPER, P.C., P.O. BOX 2266 EADS STATION, ARLINGTON, VA, 22202, US

(21) Appl. No.: 12/197,423

(22) Filed: Aug. 25, 2008

Related U.S. Application Data
(60) Provisional application No. 60/935,653, filed on Aug. 23, 2007.

(51) Int. Cl. B05D 3/02

(52) U.S. Cl. 427/163.2; 118/708

(57) ABSTRACT

The present invention relates to a method and apparatus for coating an optical fiber. A polyethylenimine-based polymer deposition precursor that includes titanium is prepared. The optical fiber is coated with the precursor in a polymer coater, after which the coated optical fiber is heated in an ammonia oven. The method and apparatus can be used to coat optical fibers that contain a cladding or optical fibers that are already covered with one or more fibers in a temperature-resistant outer cladding.

### CROSS REFERENCE TO RELATED APPLICATIONS

This application claims the benefit under 35 U.S.C. 119(e) of U.S. Provisional Application No. 60/935,653, which was filed on Aug. 23, 2007 and is hereby incorporated by reference in its entirety.

### TECHNICAL FIELD

The present method relates to a low-cost and environmentally friendly process for producing hermetically sealed optical fiber, optical fiber cables and optical fiber sensor probes with wet chemistry methods to produce complex layers that are highly controlled, strong and resistant to degradation by hydrogen in a variety of hydrocarbon-rich environments.

### DESCRIPTION OF THE BACKGROUND ART

Several problems arise in using optical fiber sensor probes in hydrocarbon-rich environments. One significant problem is optical attenuation caused by hydrogen diffusion in and around the optical waveguide. A secondary problem is physical degradation of the sensor probe (cladding, jacketing) due to hydrogen sulfide. A tertiary problem is degradation of the sensor probes due to hydrogen diffusion. While telecommunications fiber coatings and claddings have been designed to block the uptake of OH ions, there is a significant unmet need for low-cost and effective sensor probes that can reduce hydrogen diffusion in optical fibers and hydrogen sulfide corrosion in the cables and cladding. Recent advances in long-range optical sensor technologies such as Brillouin and Raman scattering sensors have increased the value and need for such technology.

Past attempts to address these problems have been deficient. While TiN has been proposed in previous patents as a “hermetic seal” for optical fibers, these patents did not include methods sufficient to address the unmet market need for long-range hydrocarbon sensor probes.

A related patent in this area is U.S. Pat. No. 4,735,856. This patent teaches an effective method with which to produce hermetically sealed optical fibers using chemical vapor deposition (CVD). It also discusses the efficacy of titanium nitride as a barrier to hydrogen. However, this method suffers from a number of limitations. CVD is expensive and uses toxic metal-organic compounds. The cost, vacuum chamber and other limitations of the technique limit CVD as an economic choice in many applications for layered TiN on outer protective sheaths.

Recently, new methods have emerged that allow the deposition of ordered layers (epitaxial) of oxides and nitrides via polymer suspension. This class of deposition methods was disclosed in the article Polymer-assisted deposition of metal-oxide films, Jia et al., Nature Materials 3, 529-532 (2004). The advantages of this class of methods include non-toxic precursors and by-products, relatively low-temperature deposition, and low capital costs. In these deposition methods, the polymer suspension has a very low surface tension, which allows for ultrathin layer deposition. Recent experimental results indicate that ultrathin layers of TiN are an extremely good hydrogen barrier, even at high temperatures.

### SUMMARY OF THE INVENTION

The present method relates to a low-cost and environmentally friendly process for producing hermetically sealed optical fiber, optical fiber cables and optical fiber sensor probes that use wet chemistry methods to produce complex layers that are highly controlled, strong and resistant to degradation by hydrogen in a variety of hydrocarbon-rich environments. One advantage of this method is the use of a single low-capital-cost technology (polymer assisted deposition) to address coatings at all scales.

In one aspect there is provided a method of coating an optical fiber comprising the steps of: preparing a polyethylenimine-based polymer deposition precursor that includes titanium; using a polymer coater to coat the optical fiber with the precursor; and heating the coated optical fiber in an ammonia oven.

In another aspect there is provided an optical fiber coater comprising: a polymer coater for coating an optical fiber with a polyethylenimine-based polymer deposition precursor that includes titanium; a heated ammonia oven; and a control system that adjusts one or more of the following based upon the coated fiber thickness: (a) the concentration of ammonia (b) the rate of fiber throughput, and (c) the viscosity of the polymer precursor.

The process and apparatus can also be used to coat optical fiber that is covered by a temperature-resistant cladding material or optical fiber cable that is covered with one or more fibers in a temperature-resistant outer cladding.

### BRIEF DESCRIPTION OF THE DRAWINGS

The following description will be better understood with reference to the drawings in which:

FIG. 1 shows a flowchart of the present method as a replacement for a CVD process;

FIG. 2 shows a flowchart of the present method for coating of cladding; and

FIG. 3 shows a flowchart of the present method for coating sensor probes and multifiber sensor probes of all length.

### DETAILED DESCRIPTION OF THE PREFERRED EMBODIMENTS

The present method relates to an adaptation of the method described by Jia et al for coating optical fibers, optical fiber cables and optical fiber sensor probes. The same method, precursors, and capital equipment may be used to coat optical fiber, high temperature optical fiber cladding, optical fiber cables, and complete sensor probes. Although the figures focus on TiN, one skilled in the art will appreciate there are essentially equivalent methods for other nitrides, sulfides, oxides, and carbides that can be deposited in a polymer suspension.

The chemistry of the methods is relatively simple and easy. The chemical byproducts are non-toxic and safe once they are passed through an exhaust burner. In the present method, the deposition of TiN requires an ammonia atmosphere. However, ammonia is readily available and benign when handled properly. Jia et al. describe the polymer formulation, specifically how to bind Ti within the polymer solution.

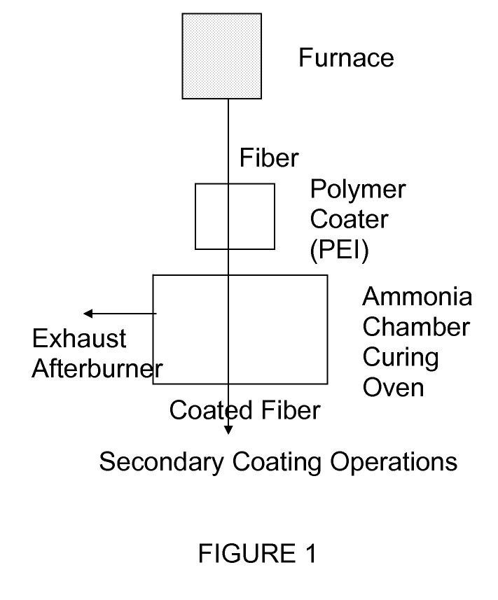

FIG. 1 shows the first configuration of the present method setup, which is similar to, but distinct from CVD-based methods such as disclosed in U.S. Pat. No. 4,735,856 and others. In addition to benign precursors and byproducts, the present method eliminates the need for much of the capital equipment presently used in fiber coating operations. The polyethylenimine (PEI) based solution requires a coater no more complicated that that used for fiber cladding.

The heated ammonia chamber preferably has a form factor that is very long and thin. This has several advantages including minimum volume and rapid throughput. The organic suspension bakes off in the ammonia chamber, leaving an ordered (dense) layer of TiN.

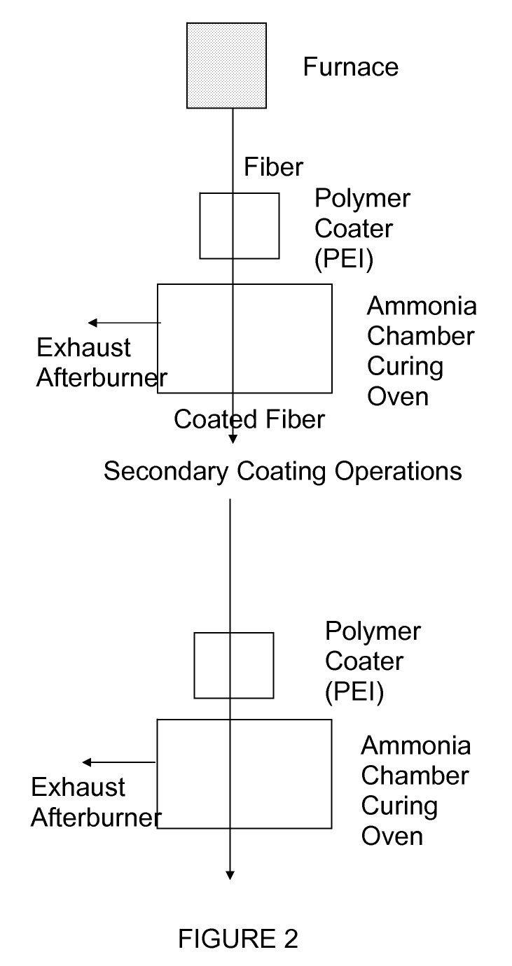

FIG. 2 shows a flow chart for coating the cladding. This method may be used on certain high-temperature fiber claddings already in use. For example, coating metal-coated fiber with TiN or other ceramic materials would provide an additional hydrogen barrier.

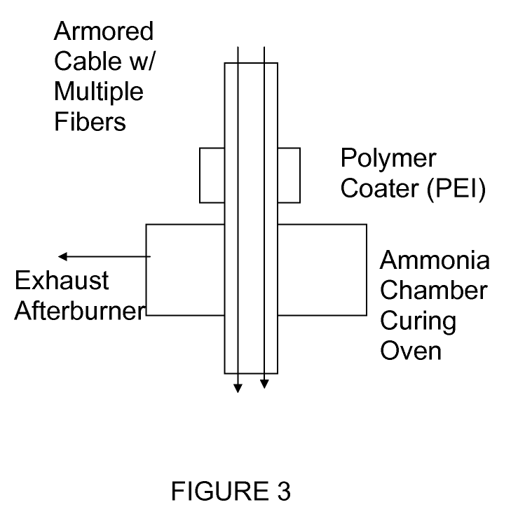

FIG. 3 shows a multiple fiber implementation and demonstrates the ability of the present method to be used for coating sensor probes in hydrocarbon rich environments and multifiber sensor probes of all lengths. Unlike the vacuum deposition methods, the PEI-based deposition can be performed directly on cables, even in the field. The only requirement is that the cable can survive the bakeoff temperature, which is in the order of several hundred degrees Celsius.

Although the invention has been disclosed in terms of a number of preferred embodiments, it will be understood that variations and modifications could be made thereto without departing from the scope of the invention as defined in the following claims.

1. A method of coating an optical fiber comprising the steps of:
preparing a polyethylenimine-based polymer deposition precursor that includes titanium;
using a polymer coater to coat the optical fiber with the precursor; and
heating the coated optical fiber in an ammonia oven.

2-6. (canceled)

7. The method of claim 1 wherein the optical fiber is covered with a temperature-resistant cladding material.

8. The method of claim 7 wherein the polymer coater coats the cladding of the optical fiber with the precursor.

9. The method of claim 1 further comprising the step of:
covering the optical fiber cable with one or more fibers in a temperature-resistant outer cladding before using the polymer coater to coat the covered optical fiber with the precursor.

10. An optical fiber coater comprising:
a polymer coater for coating an optical fiber with a polyethylenimine-based polymer deposition precursor that includes titanium;
a heated ammonia oven; and
a control system that adjusts one or more of the following based upon the coated fiber thickness:
(a) the concentration of ammonia
(b) the rate of fiber throughput, and
(c) the viscosity of the polymer precursor.

11. The optical fiber coater of claim 10 wherein the optical fiber has a temperature-resistant cladding material.

12. The optical fiber coater of claim 10 wherein the optical fiber cable has one or more fibers in a temperature-resistant outer cladding.
